(19) United States
(12) Patent Application Publication
(10) Pub. No.: US 2022/0388389 A1
(43) Pub. Date: Dec. 8, 2022

(54) HYBRID MODULE WITH SEPARATING CLUTCH WHICH IS OPTIMIZED WITH RESPECT TO DISPLACEMENT FRICTION

(71) Applicant: Schaeffler Technologies AG & Co. KG, Herzogenaurach (DE)

(72) Inventor: Marc Finkenzeller, Gengenbach (DE)

(73) Assignee: Schaeffler Technologies AG & Co. KG, Herzogenaurach (DE)

(21) Appl. No.: 17/775,376

(22) PCT Filed: Oct. 21, 2020
(86) PCT No.: PCT/DE2020/100910

§ 371 Date: May 9, 2022

(30) Foreign Application Priority Data
Nov. 18, 2019 (DE) 10 2019 131 021.0

(51) Int. Cl. B60K 6/387; B60K 6/48

(52) U.S. Cl. CPC B60K 6/387; B60K 6/48; B60K 2006/4825

(57) ABSTRACT

A hybrid module for the powertrain of a motor vehicle, having a housing; an input shaft which can be coupled to the internal combustion engine and is rotatably mounted relative to the housing; an electric machine, a rotor support which receives a rotor of of the electric machine being permanently connected to the input shaft; and a separating clutch which is arranged at least partly radially within the rotor and at least partly axially at the same height as the rotor. The separating clutch has a first clutch component received on the rotor support in a rotationally fixed manner and a second clutch component selectively coupled to the first clutch component and provided for connecting to a transmission shaft. The second clutch component has no more than two axially spaced friction segments, and an intermediate plate of the first clutch component is arranged axially between said two friction segments.

### CROSS-REFERENCE TO RELATED APPLICATIONS

This application is the U.S. National Phase of PCT Appln. No. PCT/DE2020/100910 filed Oct. 21, 2020, which claims priority to DE 102019131021.0 filed Nov. 18, 2019, the entire disclosures of which are incorporated by reference herein.

### TECHNICAL FIELD

The disclosure relates to a hybrid module for a powertrain of a motor vehicle, such as a car, truck, bus or other commercial vehicle, having a housing, an input shaft that can be coupled to an internal combustion engine and is rotatably mounted relative to the housing, an electric machine, wherein a rotor support receiving a rotor of the electric machine is permanently connected to the input shaft, as well as a separating clutch which is arranged at least partly radially within and at least partly axially at the same height as the rotor, wherein the separating clutch has a first clutch component which is held in a rotationally fixed manner on the rotor support and a first clutch component which can be selectively coupled to the first clutch component, for providing a connection to a transmission shaft, having second clutch component.

### BACKGROUND

Generic hybrid modules are already sufficiently known in the prior art. In this context, DE 10 2018 112 281 A1, for example, discloses a hybrid module having a hydraulically cooled friction clutch.

A disadvantage of the designs known from the prior art, however, has been found that the clutches used have a relatively high displacement friction due to the relatively high number of individual friction plates when the clutch is actuated, which arises from the relative displacement of the friction plates. Another disadvantage, due to the high number of friction plates, is that a relatively high drag torque of the corresponding clutch components acts on the powertrain.

### SUMMARY

It is therefore the object of the present disclosure to eliminate the disadvantages known from the prior art and in particular to provide a hybrid module equipped with a separating clutch that can be actuated as efficiently as possible and enables an operation of a hybrid powertrain that is improved in terms of the efficiency thereof.

According to the disclosure, this is achieved in that the second clutch component has no more than/exclusively two axially spaced friction segments, wherein an intermediate plate of the first clutch component is axially arranged between these two friction segments.

This implementation of the separating clutch as a dual-disc clutch reduces the required friction plates to a minimum. Thus, on the one hand, the drag torque acting on the rest of the powertrain is significantly reduced. In addition, due to the reduction in friction plates, the loss of friction that occurs when the clutch is actuated is also significantly reduced.

Further advantageous embodiments are explained in more detail below.

Accordingly, it is also advantageous if the two friction segments are connected to a common base support. The base support is more preferably coupled to a hub. As a result, the second clutch component can be produced as easily as possible.

It is also advantageous if a first friction segment has a support disc which directly forms the base support or is connected thereto.

If a second friction segment is fastened to the base support in an axially resilient manner, the softest possible axial connection of the two friction segments is achieved, which at the same time produces the lowest possible friction loss during the relative axial displacement thereof.

In addition, it is expedient if the intermediate plate is connected to the rotor support so that it can be displaced axially relative to the rotor support by means of at least one first leaf spring unit.

In this context, it is also advantageous if the intermediate plate interacts with the at least one first leaf spring unit in such a way that the intermediate plate rests against a stop formed by the rotor support when the separating clutch is in an open position. This enables forced positioning in the open position of the clutch, which further reduces the drag torque.

If a pressure plate assigned to the first clutch component is connected to the rotor support by means of at least one second leaf spring unit so that it can be displaced relative to the rotor support, the pressure plate is also as space-saving as possible and is connected directly to the rotor support.

It is also advantageous if a hydraulic slave cylinder is received on the housing side to actuate the separating clutch, wherein a piston of the slave cylinder is coupled for movement to the pressure plate by means of a pressure disc axially penetrating the rotor support.

The prestressing force generated by the at least one second leaf spring unit is more preferably selected such that when the slave cylinder is in a pressureless state, the piston is pushed back into the engaged position thereof by the at least one second leaf spring unit.

If the rotor support is connected to the input shaft in a torque-proof manner by means of an intermediate hub, the assembly of the hybrid module is further simplified.

Furthermore, it is advantageous if the separating clutch is implemented while running thy.

In addition, it is expedient if the rotor support is operatively connected to a rotor position sensor that detects a rotational angle position of the rotor.

In other words, according to the disclosure, a hybrid module is implemented in a P1 arrangement, wherein the separating clutch is designed with an optimized displacement friction. The separating clutch is used in the rotor as a dual-disc clutch with an axially soft connection of the clutch discs (friction segments).

### BRIEF DESCRIPTION OF THE DRAWINGS

In the following, the disclosure is now explained in more detail with a FIGURE.

The single FIGURE shows a longitudinal sectional view of a hybrid module according to the disclosure according to an exemplary embodiment.

### DETAILED DESCRIPTION

As can be seen in the FIGURE, the hybrid module 1 according to the disclosure is implemented as a structural unit having an electric machine 4 and a separating clutch 7. The hybrid module 1 has what is termed a P1 arrangement, in which an input shaft 3 is directly and permanently connected to a rotor support 6 coupled to a rotor 5 of the electric machine 4. In the preferred area of use thereof, the hybrid module 1 is used in a powertrain of a motor vehicle between an internal combustion engine, not shown here for the sake of clarity, and a transmission.

The electrical machine 4 has a stator 22 which is firmly received in a housing 2 of the hybrid module 1. The rotor 5 of the electrical machine 4 is rotatably mounted relative to this stator 22. The rotatable mounting takes place via a rotor support 6 receiving the rotor 5 towards the radial outside thereof and a central bearing 23 supporting the rotor support 6 relative to the housing 2.

The rotor support 6 is implemented in several parts in this embodiment. A sleeve element 24 directly receiving the rotor 5 is firmly connected to a support flange 25. The support flange 25 runs in the radial direction/radially (r) and is supported directly on the housing 2 via the central bearing 23. In addition, the rotor support 6 has an intermediate hub 20 which is connected to the input shaft 3 in a rotationally fixed manner. The intermediate hub 20 is preferably fastened directly to the support flange 25 via a rivet connection. The intermediate hub 20 is connected in a torque-free manner to the input shaft 3 by a spline 26.

The input shaft 3 penetrates a central opening 27 in the housing 2 and is connected to a torsional vibration damper 28 in a region protruding from the housing 2. The torsional vibration damper 28 is in turn connected to an output shaft of the internal combustion engine during operation. The torsional vibration damper 28 is implemented as a dual-mass flywheel with an integrated centrifugal pendulum.

According to the disclosure, a separating clutch 7 is connected to the rotor support 6, which separating clutch 7 is implemented as a dual-disc clutch. The separating clutch 7 has a first clutch component 8a, which is directly connected to the rotor support 6/is received thereon. A second clutch component 8b of the separating clutch 7 is prepared for further connection to a transmission input shaft of the transmission.

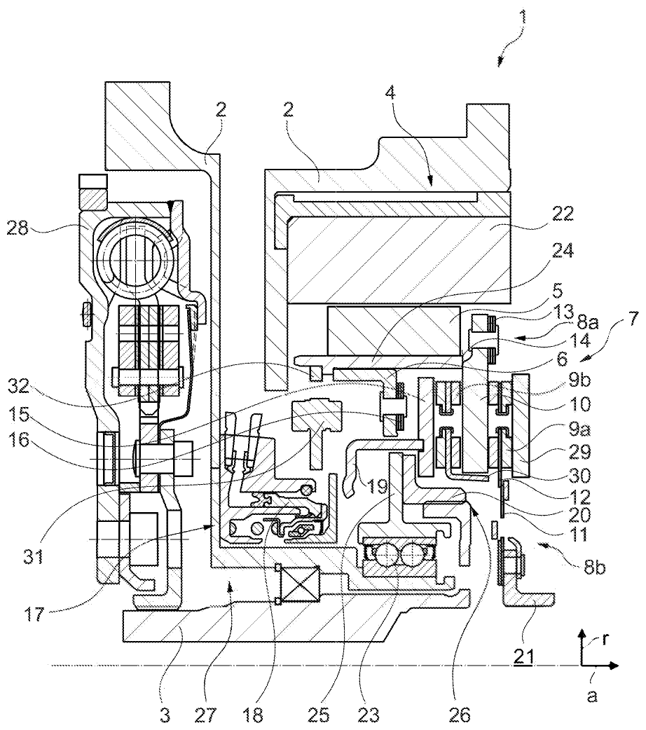

Furthermore, it can be seen from FIG. 1 that the first clutch component 8a has an intermediate plate 10 fastened to the rotor support 6 in a torque-free manner, a pressure plate 15, and a counter-pressure plate 29. The three plates 10, 15, 29 are spaced relative to one another in an axial direction/axial (a) and are received on the rotor support 6 so as to be displaceable relative to one another.

It can be seen that the pressure plate 15 is attached to the rotor support 6, namely the support flange 25 here, by means of a (second) leaf spring unit 16, so that it is coupled in a rotationally fixed manner to the rotor support 6, but is axially displaceable relative thereto. The intermediate plate 10 can also be displaced axially relative to the rotor support 6 via a (first) leaf spring unit 13, but is attached to the latter in a torque-free manner. The counter-pressure plate 29 is typically fastened to the rotor support 6 axially and in a rotationally fixed manner.

The pressure plate 15 is coupled for movement by means of a pressure disc 19 with a hydraulic slave cylinder 17, namely a displaceable piston 18 of the slave cylinder 17. The slave cylinder 17 is likewise received in a housing 2. The slave cylinder 17 is designed as a concentric clutch slave cylinder (CSC).

The second clutch component 8b has two friction segments 9a, 9b, which are axially soft relative to one another and which each form a clutch disc. A first friction segment 9a is connected to a base support 11 via the support disc 12 thereof, which is formed from an axially deformable sheet metal. The base support 11 is in turn firmly connected to a hub body/hub 21, which is then connected to the transmission input shaft via a plug connection during operation. A second friction segment 9b is elastically/resiliently received in the axial direction relative to the first friction segment 9a. A coupling disc 30 of the second friction segment 9b, which is also implemented in an axially resilient manner and is formed from sheet metal, is connected to the base support 11. The two friction segments 9a, 9b are thus axially spaced from one another with the friction surfaces thereof interacting with the intermediate plate 10, wherein the intermediate plate 10 projects axially therebetween.

Furthermore, it can be seen in this embodiment that the separating clutch 7, in particular with the two friction segments 9a, 9b thereof, is arranged radially within the rotor 5. The first friction segment 9a is also arranged axially at the same height as the rotor 5.

The rotor support 6 is also designed in such a way that, in an open position of the separating clutch 7, the intermediate plate 10 rests against a stop 14 formed by the rotor support 6, here by an axial end face of the sleeve element 24.

A rotor position sensor 31 is used to determine a rotational angle position of the rotor 5. The rotor position sensor 31 interacts with an encoder part 32 received on the rotor support 6, here the sleeve element 24. The rotor position sensor 31 is located radially within the sleeve element 24.

In other words, according to the disclosure, a rotor-integrated separating clutch 7, designed as a dual-disc clutch, is implemented. The discs 9a, 9b of the separating clutch 7 have an axially soft connection (no displacement friction). The separating clutch 7 is actuated by means of a hydraulic actuator and CSC17. A rotor position sensor 31 is also integrated.

The hybrid module 1 has an electric motor 4, a rotor-integrated separating clutch 7, a hydraulic releaser 17 and a rotor position sensor 31. The rotor 5 of the electric machine 4 is mounted on the housing 2 via the central bearing 23 and receives the rotor (encoder part 32) of the rotor position sensor 31. The connection to the internal combustion engine (or damper 28) takes place via a hub 20 riveted to the rotor support 6 and an intermediate shaft 3. The intermediate shaft 3 is mounted in the housing 2. The separating clutch 7 is integrated into the rotor and is designed as a dual-disc clutch. The pressure plate 15, intermediate plate 10 and counter-pressure plate 29 are assigned to the electric machine 4. The pressure plate 15 and intermediate plate 10 are connected to the rotor 5 via leaf springs 13, 16 in an axially displaceable manner. The intermediate plate 10 is pressed by the leaf spring force in the open state of the clutch 7 against a stop 14 on the rotor 5 and is thus positioned axially. The forced positioning reduces the drag torque to a minimum. The leaf springs 16 between the pressure plate 15 and the rotor 6 provide the restoring force for the releaser 17. Due to the axially soft connection of the discs 9a, 9b, no displacement friction forces occur. The discs 9a, 9b are connected via the hub 21 to the transmission. The separating clutch 7 is actuated via a CSC 17. If oil pressure is applied thereto, the separating clutch 7 is pressed shut via a pressure disc 19. The actuating force is supported internally via the central bearing 23.

### LIST OF REFERENCE NUMBERS

1 Hybrid module

2 Housing

3 Input shaft

4 Electric machine

5 Rotor

6 Rotor support

7 Separating clutch

8a First clutch component

8b Second clutch component

9a First friction segment

9b Second friction segment

10 Intermediate plate

11 Base support

12 Support disc

13 First leaf spring unit

14 Stop

15 Pressure plate

16 Second leaf spring unit

17 Slave cylinder

18 Piston

19 Pressure disc

20 Intermediate hub

21 Hub

22 Stator

23 Central bearing

24 Sleeve member

25 Support flange

26 Spline

27 Opening

28 Torsional vibration damper

29 Counter-pressure plate

30 Coupling disc

31 Rotor position sensor

32 Encoder part

1. A hybrid module for the a powertrain of a motor vehicle, comprising: a housing, an input shaft configured to be coupled to an internal combustion engine and rotatably mounted relative to the housing, an electric machine, wherein a rotor support receiving a rotor of the electric machine is permanently connected to the input shaft, as well as a separating clutch which is arranged at least partly radially within and at least partly axially at a same height as the rotor, wherein the separating clutch has a first clutch component which is held in a rotationally fixed manner on the rotor support and a second clutch component configured to be selectively coupled to the first clutch component and which is provided for connecting to a transmission shaft, wherein the second clutch component has no more than two axially spaced friction segments, wherein an intermediate plate of the first clutch component is arranged axially between said two friction segments.

2. The hybrid module according to claim 1, wherein the two friction segments are connected to a common base support.

3. The hybrid module according to claim 2, wherein a first friction segment of the two friction segments has a support disc which directly forms the base support or is connected thereto.

4. The hybrid module according to claim 3, wherein a second friction segment of the two friction segments is fastened to the base support in an axially resilient manner.

5. The hybrid module according to claim 1, wherein the intermediate plate is connected to the rotor support so that it can be displaced axially relative to the rotor support by at least one first leaf spring unit.

6. The hybrid module according to claim 5, wherein the intermediate plate interacts with the at least one first leaf spring unit in such a way that the intermediate plate rests against a stop formed by the rotor support when the separating clutch is in an open position.

7. The hybrid module according to claim 5, wherein a pressure plate assigned to the first clutch component is connected to the rotor support so that it can be displaced relative to the rotor support by at least one second leaf spring unit.

8. The hybrid module according to claim 7, wherein a hydraulic slave cylinder is received on a housing side to actuate the separating clutch, wherein a piston of the slave cylinder is coupled for movement to the pressure plate by a pressure disc axially penetrating the rotor support.

9. The hybrid module according to claim 1, wherein the rotor support is connected to the input shaft in a torque-free manner by an intermediate hub.

10. The hybrid module according to claim 1, wherein the separating clutch is implemented while running dry.

11. A hybrid module for a powertrain of a motor vehicle, comprising:
a housing;
an input shaft configured to be coupled to an internal combustion engine and rotatably mounted relative to the housing;
an electric machine having a rotor and a rotor support, wherein the rotor is rotatably mounted on the rotor support and the rotor support is permanently connected to the input shaft; and
a separating clutch arranged at least partly, radially within the rotor,
wherein:
the separating clutch has a first clutch component held in a rotationally fixed manner on the rotor support and a second clutch component configured to be selectively coupled to the first clutch component;
the second clutch component has no more than two axially spaced friction segments;
the first clutch component includes an intermediate plate arranged axially between the two friction segments; and
the intermediate plate is positioned axially adjacent to the rotor support and is connected to the rotor support in such a way that the intermediate plate is displaceable axially relative to the rotor support by a first leaf spring unit.

12. The hybrid module according to claim 11, wherein the first clutch component includes a pressure plate connected to the rotor support in such a way that the pressure plate is displaceable relative to the rotor support by a second leaf spring unit.
